(19) United States
(12) Patent Application Publication
(10) Pub. No.: US 2013/0209838 A1
(43) Pub. Date: Aug. 15, 2013

(54) LARGE FORMAT BATTERY PACKAGING SYSTEM

(71) Applicant: Ultralife Corporation, (US)

(72) Inventors: Michael Manna, Canandaigua, NY (US); Andrew Naukam, Rochester, NY (US)

(73) Assignee: Ultralife Corporation, Newark, NY (US)

(21) Appl. No.: 13/766,975

(22) Filed: Feb. 14, 2013

Related U.S. Application Data
(60) Provisional application No. 61/599,090, filed on Feb. 15, 2012.

(51) Int. Cl. H01M 10/50

(52) U.S. Cl. CPC H01M 10/5018
USPC 429/7; 429/120; 429/71; 429/62; 429/72

(57) ABSTRACT

A large format battery packaging system provides for safety, efficiency and reliability of chemically generated DC current. Each cell is immersed or submerged in a thermally conductive dielectric medium for the purpose of consistently regulating cell temperature. Internal electronics may also be employed to manage both the charge and discharge cycles and the heat generated therefrom.

This application claims priority under 35 USC §119(e) from U.S. Provisional Patent Application No. 61/599,090, for a LARGE FORMAT BATTERY PACKAGING SYSTEM, filed Feb. 15, 2012 by M. Manna et al., which is hereby incorporated by reference in its entirety.

The following disclosure is directed to the packaging of a large format battery for the purpose of enhancing safety, efficiency and reliability of the system. The large format battery consists of one or more cells, connected in series and/or parallel, to make up the final power configuration contained within a protective enclosure. Furthermore, the enclosures are filled with a thermal regulating medium such as a fluid to provide a consistent and controllable operating temperature for the cells immersed therein. Additionally, voltage control electronics, perhaps in combination with a temperature management system, may be included within the package to substantially improve large format battery performance.

### BACKGROUND AND SUMMARY

In order to accommodate evolving applications, batteries must store more energy per unit volume and weight, and be capable of undergoing many thousands of charge-discharge cycles. Large Format Batteries, referred to hereinafter as “LFB”, are defined, for the purpose of this specification, as batteries having at least a 20 A/hr rating and weighing more than 40 pounds. This further defines a class of batteries that are of particular interest as a primary component in the evolving markets associated with storage of electricity for grid-connected backup and buffering (e.g., eco-generated electricity from wind turbines, solar installations, etc.). Given the extraordinary emphasis for alternative energy sources, batteries have become an essential component in the power supply chain for portable electrical energy, as well as to provide a power reservoir for load leveling and the storing of surplus power generated from hydro, solar and/or wind power.

The primary emphasis for improving battery energy density has been directed toward the complex, interrelated physical and chemical processes between various electrode metals and electrolytes. Recently, however, conventional battery packaging has become a notable limitation to battery power density, shelf life, cyclical demands, and reliability due to thermal management issues that degrade the overall performance of high power, large format batteries at the individual cell level. In cold temperatures, batteries perform poorly because of internal resistance and retarded electrochemical reactions. On the other hand, elevated temperatures adversely affect the performance, reliability, safety and durability from accelerated electrode erosion, warping, plate separation and dielectric breakdown. Therefore, it is desirable to operate batteries within a specific temperature range that is optimum for performance, longevity and safety. The optimal operating temperature range varies according to the galvanic chemistry, however it is generally accepted that lead acid, nickel metal hydride (NiMH), and lithium ion (Li-Ion) are generally most efficient within the temperature range of about 25° C.-45° C. However, in the case of extended battery dormancy, in the interest of longevity, a temperature below well 25° C. may be desirable.

One objective of a thermal management system in a LFB package or enclosure is to assure a uniform temperature for the individual cells of the battery, preferably within a temperature tolerance of +/−2° C. from an optimum temperature. Thermal management techniques typically include the use of fluids including air, various liquids, phase change material, or a combination of these mediums for heating, cooling, ventilation and possibly dielectric insulation. The thermal management system may be passive, relying only on the ambient environment and some heat exchanging components, or active, where temperature regulation is accomplished using a thermostat(s) and a circulating medium. The heat transfer methodology has a significant impact on the performance, weight, footprint, cell packing density and additional cost of the large format battery system. The embodiments disclosed herein accommodate bi-directional transfer of heat energy by placing individual cells in direct contact with a dielectric medium such as a fluid or gel within a battery enclosure and may further include circulating the thermal medium though natural convection or possibly under mechanical control to regulate the heat into and out of the enclosure and thereby control the temperature of the cells.

The LFB packaging systems disclosed incorporate an outer enclosure, in which the large format battery cells are enclosed, along with a thermally conductive medium such as a fluid, gel, or polymer material into which the cells are immersed and submerged, such that the medium fills any voids between the cells. The enclosure may, or may not, have a vent for pressure relief and for fire safety, and to assist in maintaining contact pressure between the plates to improve overall cell resistance and longevity.

The LFB enclosure further includes at least one set of positive and negative terminals for interconnection to a load or another LFB. For example, it is conceivable that a LFB may include one or more arrays of interconnected cells therein, whereby a plurality of taps may be provided as positive and negative terminals, which may then be interconnected with one another or additional LFBs to provide a desired voltage output. As will be further appreciated the manner in which the cells in an array are interconnected (e.g., parallel and/or series) provides for a spectrum of power capacity from low current/high voltage to higher current/lower voltage applications. The battery enclosure can be constructed from either conductive or non-conductive materials, depending the application. Materials may include plastics and polymers, metals, composites, or ceramics, each with inherent cost and/or safety benefits. Notably, in the case of a conductive material the entire battery enclosure could itself provide the power terminal (e.g. negative). Additionally, each LFB may further include internal electronics to provide thermal and safety management as well as circuitry to control re-charging from multiple energy sources such as; a grid-connected power supply, solar panels, wind turbines, fuel cells, or any combination thereof.

The LFB may further include an integrated “gauge” or similar component that indicates the state of the cells/array(s) therein, such as remaining power in the battery typically expressed in amp/hrs. The LFB also may include internal electronics for charging, power conditioning, power safety monitors, and power conversion circuits for dc to dc or an inverter for dc to ac power options.

As suggested above, this disclosure further contemplates that two or more discrete LFB modules could be physically and electrically interconnected and used in conjunction with one another for the purpose of on-site assembly of a multi-module battery bank. The deployment of such a modular LFB design may also result in easier handling and shipping, as well as enable meeting DOT requirements for the safe transporting of high energy LFBs. Additionally, in multi-module applications the temperature management components could be shared amongst several interconnected LFBs. Another aspect contemplated by the disclosed LFB system is that the cooling medium used may be one that is available on-site or is able to be shipped in a separate container and filled on-site to minimize the LFB ship weight. Such a system may also be drained whenever necessary, thereby permitting the potential recycling of the thermal medium for use in other LFBs.

Large format battery packs typically contain some battery cells that are close to the outer walls of the enclosure, while centrally located battery cells are themselves surrounded by other cells. In uninsulated enclosures, those cells closest to the outer walls have a thermal profile that may be largely a function of the thermal coupling with the ambient environment outside the enclosure, whereas cells more inward in an array are less affected by the ambient environment and more by the surrounding cells. It is possible that in a large or densely packed array, interior cells suffer from detrimental heat energy that is captivated. When a battery pack is discharging, the amount of heat generated is approximately the same in each cell, however, depending on the thermal path of coolant amongst such cells a wide range of temperatures are possible. Similarly, different cells reach different temperatures during a recharging process. Accordingly, if one cell is at an increased temperature with respect to the other cells, its charge or discharge resistance will be different, and therefore it may charge or discharge at a different rate than the other cells. As a significant temperature differential within an array of interconnected cells may lead to a decline in the performance of the overall battery operation, one aspect of the disclosed embodiment is the use of various means to control the flow of the thermally conductive medium. For example, through the use of baffles, diverters and flow constrictors, a cell's exposure to the cooling media is regulated according to cell location within the battery enclosure.

Therefore, the embodiments disclosed herein include an enclosing case structure for a multi-cell, high current battery assembly.

An object of the disclosed cell packaging is to provide a battery enclosure that ensures safety from fire and/or explosion of the battery cells due to over temperature or overloads from excessive discharging or charging.

A further object of the disclosed embodiment is to include electronic circuits within the enclosure to support battery functions such as power conditioning, cell temperature, and charging circuits. Moreover, the disclosed cooling methods and medium may also be employed with respect to such circuits and similar components in order to assure that they also are maintained within a desired operating temperature range.

Disclosed in accordance with one embodiment is a large format battery system, comprising: at least one battery enclosure having an interior and exterior surface; at least one battery cell contained within the battery enclosure; a fluid medium contained within and in direct contact with the interior surface of said battery enclosure, said medium also being in direct contact with at least one cell for exchanging heat from the at least one battery cell to the fluid medium; and a heat exchanger thermally coupled to said medium to alter the thermal energy contained within said fluid medium.

In accordance with an additional aspect of the disclosed LFB is an active cooling and heating system to maintain battery temperature within a defined operating range.

And yet another objective is to provide a electrochemical reservoir for the purpose of storing surplus eco-generated electrical power.

In accordance with yet another aspect of the disclosed LFB is to provide load leveling with alternative energy sources.

Other and further objects, features and advantages will be evident from a reading of the following specification and by reference to the accompanying drawings forming a part thereof, wherein the examples of the presently preferred embodiments are given for the purposes of disclosure.

### BRIEF DESCRIPTION OF THE DRAWINGS

FIGS. 1 and 2 are isometric views of passively heated and cooled large format battery packages;

FIG. 3 is an isometric view of a plurality batteries, each including a heat exchanging surface operatively associated therewith;

FIG. 4 is a cutaway view of an exemplary battery cooling system; and

FIGS. 5-9 are top down views of various cell configurations for arrays of cells within enclosure of various shapes and sizes.

The various embodiments described herein are not intended to limit the disclosure to those embodiments described. On the contrary, the intent is to cover all alternatives, modifications and equivalents as may be included within the spirit and scope of the methods and the apparatus disclosed herein.

### DETAILED DESCRIPTION

For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

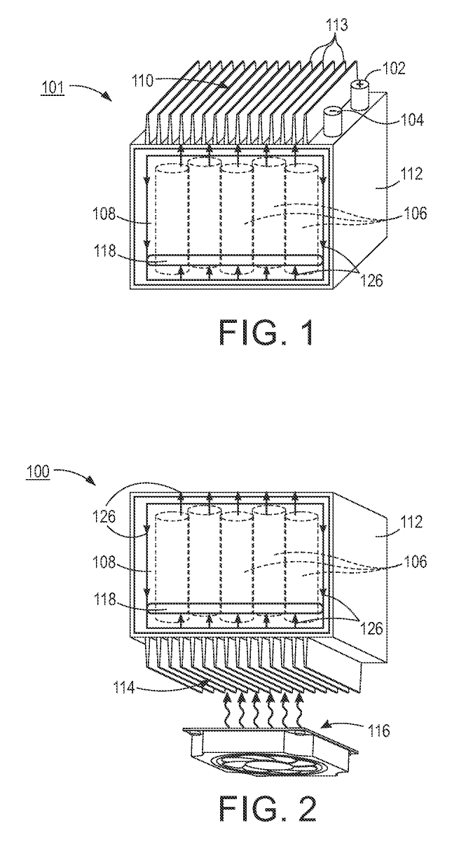

Referring now to the drawings where the showings are for the purpose of illustrating embodiments of large format battery packaging system and method depicted in FIG. 1 is a battery enclosure employing external fins as a cooling mechanism. The embodiment of FIG. 1 is shown using integrated thermal fluid medium principles and concepts as one aspect of the disclosed embodiments. More specifically, the large format battery system 101 comprises a battery cell housing or enclosure 112, a plurality of individual cells 106, electrically interconnected to provide a specified terminal voltage between anode 102 and cathode 104, and a thermally conductive fluid medium 108.

In the passive thermal systems of FIGS. 1 and 2, convection currents as generally illustrated by arrows 126 occur within thermal medium 108 as it heats up and expands, making the lower portion of medium 108 in enclosure 112 less dense and therefore lighter than the surrounding medium. Thus, having the warmer fluids rise, while the cooler fluids descend, sets up a circuitous pattern of flow with respect to the cells 106 and heat exchanger 110 that either forms part of, or is thermally coupled to, the upper surface of enclosure 112. Accordingly, convection currents are responsible for movement of the fluid, both by the heating from cells 106 and cooling by heat exchanger 110 in FIG. 1. The thermal medium may include the use of fluids including air, various liquids, phase change materials, or a combination of these mediums. The thermal medium 108, within battery enclosure 112, provides for the transfer of heat, to and from the cells 106 and heat exchanger 110, with the radiating fins 113 of the heat exchanger further releasing the heat into the ambient air or environment surrounding the surface area of battery enclosure 112.

Similarly, as illustrated in FIG. 2, an inverse process may be employed in the event the battery internal temperature is suppressed below the most efficient operating range of about 25° C.-45° C. In this case externally generated thermal energy may be provided from a heat source 116 and transferred into the thermal medium 108 via heat absorber 114 and, as previously discussed, the convection currents within thermal medium 108 would distribute the thermal energy throughout the interior of battery enclosure 112. It will be further appreciated that the heat source 116 could be provided by one, or a combination of energy sources, for example; geothermal, solar, electrical or from the combustion of organic material, such as natural gas, coal, wood, oil and their derivatives. It is further contemplated that heating or cooling may be accomplished via the interconnection of multiple large format battery systems, whereby the thermal medium is circulated amongst multiple systems and/or the thermal energy is transferred between systems (e.g., excess thermal energy from a system in use could be used to maintain temperature for an unused, or at least cooler, system). Battery cell temperature regulation is accomplished by either controlling the intensity of heat energy provided by the heat energy source 116 or by restricting the flow of thermal medium 108 through heat absorber 114 with a thermostatically controlled valve or baffle 118.

In the event that excess external electrical power is available, it is further contemplated that a resistance heater(s) or similar heat generating device(s) could be integrated within the heat exchanger 114 and energized such that the heat generating device(s) provides heat energy that is transferred to the cells through the heat exchanger and thermal medium 108. Temperature regulation is accomplished by thermal sensors controlling the amount of external power provided to the heat generating device(s). Moreover, the present disclosure contemplates the use of both heating and the cooling methods in combination with the convection flow of the medium in order to provide for overall thermal regulation at both ends of the temperature spectrum.

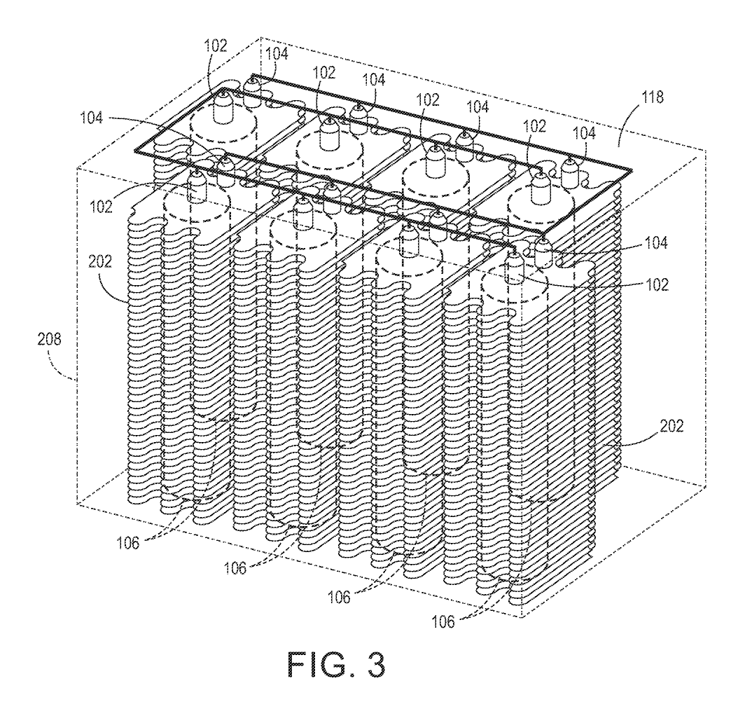

Referring now to FIG. 3, the primary means for cooling battery cells 106 consists of the conductive radiation of heat energy to/from cooling fins 202, attached to or between cells and extending into the surrounding medium. It will be appreciated that the arrangement and orientation of fins 202 may be dependent upon the manner in which cooling and/or heating is accomplished and the medium used (e.g., vertical fins may facilitate improved flow of the thermal medium 108). Battery cells 106, with cooling fins 202 would be further encased within a large battery enclosure 208 to provide a localized environment with a thermally conductive fluid medium to maximize the heat transfer capacity from the cells.

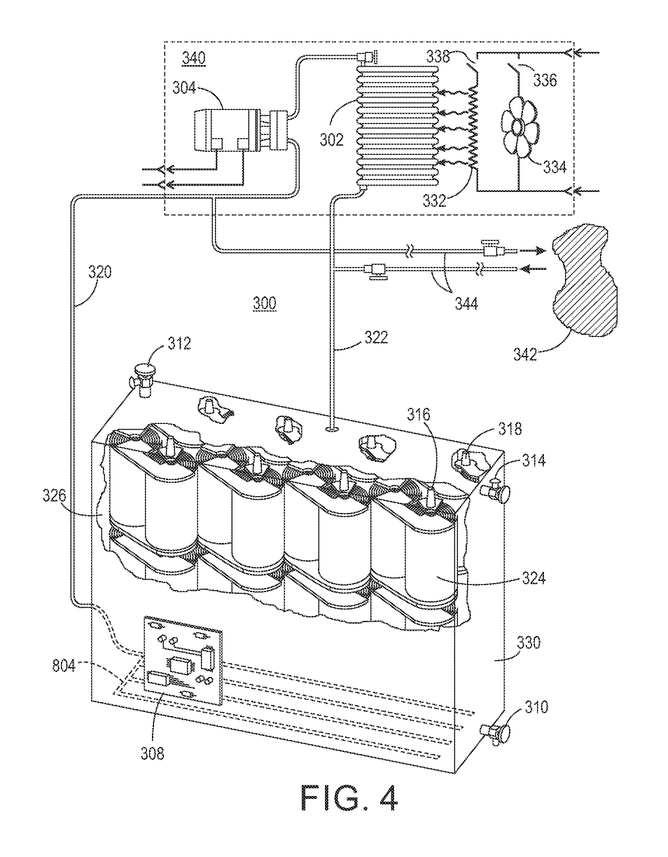

As depicted in FIG. 3, the interior of battery enclosure 208 is filled with a thermal medium (118) and is in direct contact with the cell casing and radiating fins to conduct heat energy toward or away from the core of each cell contained within housing or enclosure 208. The cells may be electrically interconnected in a parallel/series configuration to provide the required current and/or voltage. The benefit of this finned-cell configuration within a battery enclosure having a thermal medium is derived from the fact that a denser thermal medium has a higher specific heat. Therefore, the cells each have the advantage of a high heat absorbing medium surrounding the cell itself, assuring a more uniform and controlled temperature throughout the entire battery enclosure. The battery enclosure 208 itself further exchanges heat either passively as described above or actively with the use of a forced air, refrigeration, or a circulating coolant fluid as will now be generally described relative to FIG. 4.

Turning to FIG. 4 the aforementioned methods of fluid cooling and/or heating are intended for use in a large format battery system having a total volume measured in cubic feet, typically in the range of at least 25-100 ft³ and weighting 350-2000 lbs. Given the overall magnitude and high potential energy of such LFB installations, the system depicted in FIG. 4, provides unique opportunities for heat management, efficiency, longevity and safety. Active temperature management for large format battery system 300 is an important component in providing for enhancing safety, longevity and efficiency. Chemically produced electricity provides a reaction on both the recharge and discharge cycles, which is substantially determined by the internal resistance during charging and the external resistance during discharge, where dissipated heat energy is a function of power. Therefore, as the resistance approaches infinity current goes to zero and no heat is generated, whereas lower resistivity maximizes both heat and current.

As previously noted, overall thermal management of a large format battery system requires the ability to add, as well as extract heat, from the battery cells in order to stay within a desired operating range of 25° C.-45° C. (e.g., Li-Ion cells). As illustrated in FIG. 4, the cooling system provided has each cell 324 immersed in a thermally-conductive fluid medium 326, which is contained within battery cell enclosure 330. The thermally-conductive medium is also preferably an insulator or dielectric material that does not provide a conductive path between battery cell terminals and other electrical interconnections within enclosure 330. Control circuitry and optional electrical components (e.g., battery charging components, power inverters, etc.) as generally represented by circuit board 308 are intended to be programmable and to provide for the receipt of temperature input signals from both within the enclosure as well as from the thermal medium source, along with charge/discharge information, and to thereby control the balance between temperature management and current regulating functions of the cells during both charging and discharging operations. It will be appreciated that certain electrical components may also be cooled (or heated) by thermal medium 326, whether they are incorporated inside the enclosure 330 with cells 324 or outside the enclosure yet still cooled by the medium. In doing so, the components themselves may, in some cases act as heat sources or heat sinks depending upon their relative temperature to the medium and/or cells.

As further illustrated in FIG. 4, an external thermal conditioning station 340 comprises a circulating pump 304, to provide for a flow of thermal medium 326 through heat exchanger 302 and battery enclosure 330. Thermal transfer accelerators, such as air/liquid circulators 334, geothermal sources 342, or refrigerants (not shown), may be included in thermal conditioning station 340, when the ambient temperature and humidity are incapable of providing the required thermal buffering (adding or taking heat away) to heat exchanger 302 at a sufficient rate. When the ambient temperatures are below 25° C., or a temperature that cannot be accommodated by the geothermal or similar heat sources, thermostatically controlled switch 338 allows a current to pass to heating element 332 to raise the temperature of the thermal medium to a mean value of about 30-35° C. Alternative sources of heat energy may also be used for heating element 332, including solar, natural gas, coal, wood, oil and geothermal 342 as noted. Furthermore, the programmatic controls on circuit board 308 may be designed so that instead of being entirely reactive to existing thermal conditions, the control techniques are proactive in nature and begin heating and/or cooling cycles based not only upon temperature of the cells within the enclosure at any particular time, but the state of the cells themselves (e.g., charging, discharging, etc.) such that the thermal regulation may indeed begin prior to the system crossing a temperature threshold.

Continuing with FIG. 4, drain 310, in combination with filling spout 314, provides a means to add or replace thermal medium 326. Medium 326 includes, once again, a fluid or gel having a high thermal conductivity, but no electrical conductivity. Examples of such a dielectric medium include; Type I insulating oil (similar to ASTM D 3487 used in transformers), Fluid XP+ Extreme™ from Xoxide and 3M™ Fluorinert Electronic Liquid FC-70. The selection criteria for an appropriate dielectric thermal medium is application specific and includes consideration for thermal conductivity, cost, toxicity, bio-degradable characteristics, corrosiveness, boiling point, dielectric constant, viscosity, volatility, and specific heat. The circulatory system of the selected thermal medium 326 can be either open to the atmosphere via vent 312 or a closed, and possibly pressurized system. The advantages of a pressurized cooling system are based on having the thermal medium being forced in and around the entire surface area of the individual cells, providing improved safety and plate contact pressure, thereby improving overall internal resistance and longevity.

the thermal medium could have a high thermal conductivity to enable the heating and cooling of the cells within the large format battery. The material could be in a non-pressurized or pressurized state within the package system. One benefit of the thermal medium is that the material itself, or an additive thereto, could prevent, extinguish and/or contain a hazardous event within the large format battery. The material will result in increased safety and will reduce creep and clearance distances on higher voltage battery designs, particularly where thermal cycling results in the movement or loosening of internal connections. Such a material also potentially improves the packaging density of the system. This material will lead to increased safety of electronics packaged within the large format battery system. The material may also increase resistance to damage from lightning strikes, electrostatic discharge, thermal cycling of components, etc. In comparison with other cooling systems, this system could be configured to avoid the use of forced air and thereby prevent the spread or propagation of a fire.

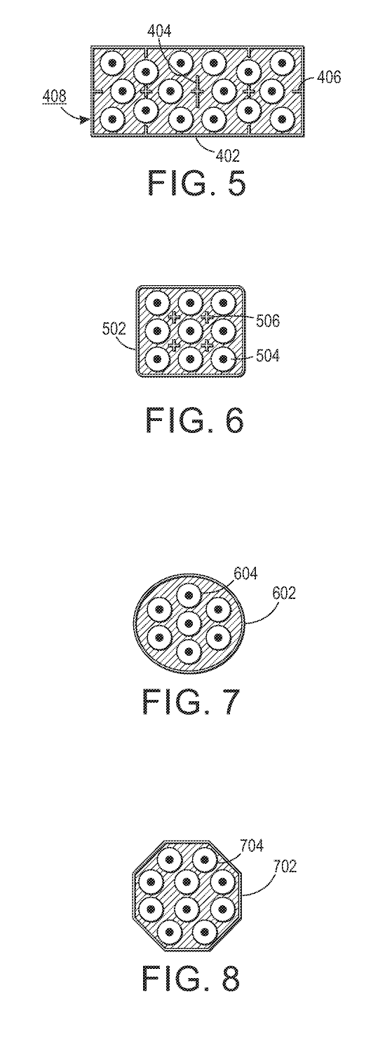

Turning now to FIGS. 5-9, various geometric cell configurations are illustrated. Uniform cooling of the core cells meets a long standing challenge that the embodiments disclosed herein endeavor to resolve. As noted above, peripheral cells have the distinct advantage of being in proximity to the exterior of the enclosure, however the interior, or core cells produce heat that is somewhat captivated by the surrounding cells and such interior cells would operate at a higher temperature. In order to reduce the differential in temperatures between peripheral and internal cells, a combination of fluid and thermodynamics is employed to provide specific geometric arrangements of the cells in conjunction with baffles, deflectors, diverters and a possibly a sparger to reduce any thermal gradients present from cell to cell.

Turning to FIG. 5, a 16-cell large format battery array is depicted within enclosure 402, having a circulating medium therein and a staggered cell arrangement 408. The system uses baffles 404 and 406 to encourage the primary flow of a thermal medium into and around the central region of the enclosure. In the depicted configuration, as in several other examples described below, the increased spacing or separation between interior cells permits the flow of the thermal medium, where natural convection or actual forced fluid flow is possible with reduced resistance from the battery cell structures.

In FIG. 6, cells 504 are arranged in a parallel, three row/column configuration within enclosure 502, and having deflectors 506 to create a turbulent flow within the inner cell region. Radial arrangements, such as seen in FIGS. 7 and 8, with cells 604, 704 in enclosures 602, 702, respectively, serve to eliminate any turbulent flow associated with corners and may result in a spiral circulation path which enhances the cooling of the core located within the vertex of the flow. In FIGS. 5-8, the flow between the surfaces of interior cells may be enhanced by not only the baffles described, but also by controlling the volume and/or pressure of the thermal medium delivered beneath or between the interior cells in particular. It is further contemplated that the large format batteries may include layered cell structures where each layer has similarly, or differently, configured arrays of cells and where the flow of the thermal medium in or between layers is also controlled by baffles as well as differential flow rates and pressures. It will be further appreciated that in the stable structure of the large format batteries, the insertion of piping and baffles to direct and control the flow of the medium may be incorporated as part of the enclosure and/or part of the structure used to support multiple cell array layers.

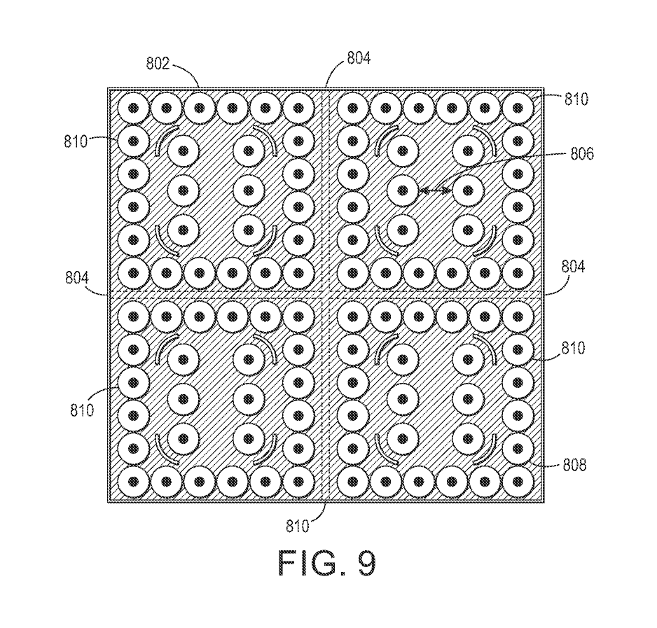

Considering FIG. 9, for example, cells 810 are shown in a large format battery having four discrete sub-sections. The core cells in each sub-section have been spaced apart by a specific distance indicated by arrow 806 that provides them the same opportunity for cooling as the closer peripheral cells of the sub-section. Baffles 808 provide for a controlled flow and are positioned to direct the thermal medium into the central core of the sub-section. A sparger, or perforated manifold, 804 (also illustrated in FIG. 4) disperses the thermal medium throughout the enclosure, notably concentrating on the central region of enclosure 802, where the heat build up is likely to be most significant.

Also contemplated is the possibility that the large format battery employs a plurality of large prismatic cells (e.g., pouches and rectangular cross-sections), and where the arrangement of such prismatic or pouch-type cells take on different configurations than those depicted in several of the figures for various cylindrical cells because they are not confined to cylindrical configurations. As will be recognized, such cells may be employed in relatively dense packing configurations and cooling of such cells may require alternative cooling equipment and media to achieve desired temperature regulation.

In conclusion, large format batteries typically include dangerous and/or flammable electrolyte solvents and materials, whereby a protective enclosure reduces or eliminates the risks associated with a hazardous fire or a venting event. Additionally the enclosure improves the resistance to lightning strikes and electrostatic discharge while providing environmental and physical protection from weather, vandalism and hostile actions. With the addition of a fluid thermal medium the overall performance and energy density of the battery is significantly improved. When paired with an external heat exchanger and internal battery management electronics the uniform temperature of the large format battery system can be controlled and monitored under idle, charge or discharge conditions, thereby promoting efficiency and longevity of the system.

It will be appreciated that several of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the description above and the following claims.

What is claimed is:

1. A battery system, comprising:
at least one battery enclosure having an interior and exterior surface;
at least one battery cell contained within the battery enclosure;
a fluid medium contained within and in direct contact with the interior surface of said battery enclosure, said medium also being in direct contact with at least one cell for exchanging heat from the at least one battery cell to the fluid medium; and
a heat exchanger thermally coupled to said medium to alter the thermal energy contained within said fluid medium.

2. The battery system of claim 1 further comprising a pump to circulate the fluid medium.

3. The battery system of claim 1 wherein said heat exchanger cools said fluid medium.

4. The battery system of claim 1 wherein said heat exchanger heats said fluid medium.

4. The battery system of claim 1 further comprising a thermostat, and where the operation of the heat exchanger is responsive to the thermostat to regulate the flow of the fluid medium.

5. The battery enclosure of claim 1 further including a drain.

6. The battery enclosure of claim 1 wherein said fluid medium is electrically non-conductive.

7. The battery enclosure of claim 1 further including electrical circuits for power conditioning.

8. The battery enclosure of claim 1 wherein the heat exchanger includes heat radiating fins.

9. The battery enclosure of claim 8 further including heat radiating fins operatively associated with at least one cell in the enclosure.

10. The battery enclosure of claim 1 further including internal partitions to control the flow of said fluid medium around the battery cell.

11. The battery enclosure of claim 1 further including a plurality of baffles to affect the flow of said medium within the enclosure.

12. The battery enclosure of claim 11 further including at least one sparger for directing the fluid medium within the enclosure.

13. The battery enclosure of claim 11 further including a manifold having a plurality of spargers operatively attached thereto for directing the fluid medium within the enclosure.
